(19) United States
(12) Patent Application Publication
(10) Pub. No.: US 2005/0027536 A1
(43) Pub. Date: Feb. 3, 2005

(54) System and method for enabling automated dialogs

(76) Inventors: Paulo Matos, (US); Brian O'Connor, (US)

Correspondence Address: REED SMITH LLP, 2500 One Liberty Place, 1650 Market Street, Philadelphia, PA, 19103-7301, US

(21) Appl. No.: 10/632,517

(22) Filed: Jul. 31, 2003

(51) Int. Cl. G10L 21/00

(52) U.S. Cl. 704/270.1

(57) ABSTRACT

A system and method for operating at least one automated dialog are disclosed. This system and method includes a definer that is accessible to a configuror, wherein the definer allows for the assemblage of the at least one automated dialog via at least one non-program coding interface; at least one data module that is incorporated into the at least one automated dialog after assemblage; an executor that incorporates the at least one automated dialog and the at least one data module into a joinder communication, and that executes an outgoing communication in accordance with the joinder communication.

### CROSS REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention is directed generally to a system and method for enabling automated dialogs and, more particularly, to a system and method for enabling a business user to assemble, schedule, operate and monitor automated dialogs with integrated workflow and reporting, routing, smart resource utilization, and improved recipient connection.

2. Description of the Background

Companies frequently need to communicate with millions of customers, hereinthroughout also referred to as recipients. Methods used to develop messages intended to reach this recipient population historically were manual in nature. Over time, certain automated technologies emerged that automated these types of communications, including bulk mailing, IVR (Interactive Voice Response), and, more recently, Web technology and email.

IVR technology enabled automated and interactive dialogs between companies and customers. Interactive Voice Response (IVR) systems were developed in the 1960s. The first IVR systems allowed a recipient to call a number, be presented with voice prompts, and enter data in response to those prompts using the dial on the telephone.

A number of innovations followed, including the use of dual-tone multifrequency (DTMF) tones for providing recipient input, and integration with speech synthesis mechanisms that combined pre-recorded words into phrases. Initially IVR systems were standalone systems. Over time, IVR capabilities were added to PBXes, and eventually to central office switches.

Speech recognition capabilities eventually progressed to the point where speech recognition could be successfully integrated with IVR systems to provide recipients with a more “natural” means by which to interact with a system in simple scenarios, such as wherein yes/no answers would suffice. Eventually, computers have become sufficiently powerful that general word recognition may be used in IVR systems.

Professional services have been offered to develop applications that allowed enterprises to accept calls from recipients, and to guide those recipients through increasingly complex transactions. Enterprises now provide a wide range of services to recipients without the recipient ever having to interact with a human operator. However, the development of IVR systems currently requires technically knowledgeable computer programmers to build interactive dialogs and to integrate those dialogs into an operating telephony delivery environment.

Automated dialog creation usually involves detailed and laborious programming. Often this involves programmatically linking different technologies through computer programming, and building decision logic and scheduling algorithms, in a piece-meal mode. This may require multiple individuals with different technical domain knowledge (i.e. telephony, IVR development, Web development, database development). Although progress has been made to reduce the time it takes to develop and deploy such systems, this process remains inflexible, complex, and therefore expensive.

VXML, short for Voice Extensible Markup Language, allows a user to interact with the Internet through voice-recognition technology, and has helped alleviate some of the problems of the complexities involved in programming for voice systems. Instead of a traditional browser, which relies on a combination of interactions with HTML via a keyboard and mouse, VXML relies on a voice browser and/or the telephone. VoiceXML builds a voice application without reliance upon proprietary techniques, but rather leverages the same infrastructure used to build Web sites. Using VXML, the user may interact with a voice browser by, for example, listening to audio output that is pre-recorded or computer-synthesized, and may submit audio input through the user's natural speaking voice, or through a keypad, such as a telephone. Applying a standard to the development of speech applications has allowed increased efficiencies in programming and speed of implementation, but has not unburdened the paradigm of development, i.e. the programmer.

However, even in light of the advances discussed hereinabove, the automated dialogs systems currently available fail to provide a system and method for enabling business users to develop computer code to generate and deploy interactive dialogs through an easy-to-use graphic user interface, that can be delivered by different media types (calls, Web pages, letter surveys, text), a system and method for enabling a business user to control the level of authentication required in order to deliver a given interactive dialog, a system and method for defining visually the content of an automated dialog, a scheduling and resource allocation mechanism that enables the system to place scheduled dialogs according to the availability of resources, a policy engine enabling the business user to prescribe what action the system should take should the recipient not be reached and to prescribe how many recipients should be contacted at a time, and a transactional data collection and display mechanism.

Therefore, the need exists for a system and method of enabling automated dialogs to enable users to develop interactive dialogs through an easy-to-use graphic user interface, for a business user to control what level of authentication is required to in order to deliver a given dialog, a scheduling and resource allocation mechanism that enables the system to place scheduled dialogs according to the availability of resources, a policy engine enabling the business user to prescribe what action the system should take should the recipient not be reached, and a transactional data collection and display mechanism.

### BRIEF SUMMARY OF THE INVENTION

A system for operating at least one automated dialog is disclosed, including: a definer that is accessible to a configuror, wherein the definer allows for the assemblage of the at least one automated dialog via at least one non-program coding interface; at least one data module that is incorporated into at least one automated dialog after assemblage, wherein the at least one data module comprises at least one information item about at least one recipient of the at least one automated dialog; an executor that incorporates the at least one automated dialog and the at least one recipient data module into a joinder communication, and that executes an outgoing communication in accordance with the joinder communication; and an interface, wherein the outgoing communication reaches the recipient through the interface and a reporter that reports data about the communication.

A system for executing at least one automated dialog is also disclosed, including, at least one non-programming interface, wherein the at least one non-programming interface includes at least one graphics wizard, and wherein entry by a configuror of at least one non-programming dialog request is facilitated by receipt of at least one non-programming interaction of the configuror with the at least one graphical wizard; a definer that is accessible to a configuror via the at least one non-programming interface, wherein the definer assembles a first portion of the at least one automated dialog in accordance with the at least one non-programming dialog request; and an executor that incorporates the first portion of the at least one automated dialog and at least one data module into the at least one automated dialog, and that executes an outgoing communication in accordance with the at least one non-programming interaction.

### BRIEF DESCRIPTION OF THE SEVERAL VIEWS OF THE DRAWING

Understanding of the present invention will be facilitated by consideration of the following detailed description of the preferred embodiments of the present invention taken in conjunction with the accompanying drawings, in which like numerals refer to like parts, and wherein:

FIG. 1 shows a high level process description according to an aspect of the present invention;

FIG. 2 shows a diagrammatical view of the system according to an aspect of the present invention;

FIG. 3 shows a depiction of a user interface for importing recipient information according to an aspect of the present invention;

FIG. 3A shows a depiction of a user interface for importing recipient information according to an aspect of the present invention;

FIG. 4 shows a depiction of a user interface for developing policy according to an aspect of the present invention;

FIG. 5 shows a depiction of a user interface for creating audio according to an aspect of the present invention;

FIG. 6 shows a depiction of a user interface for scheduling a customer program according to an aspect of the present invention;

FIG. 6A shows a depiction of a user interface for scheduling a customer program according to an aspect of the present invention;

FIG. 7 shows a depiction of a user interface for a dialog according to an aspect of the present invention;

FIG. 7A shows a depiction of a user interface for a dialog according to an aspect of the present invention;

FIG. 8 shows a depiction of a user interface for customer program creation summary according to an aspect of the present invention;

FIG. 8A shows a depiction of a user interface for reviewing and saving a call according to an aspect of the present invention;

FIG. 9 shows a diagrammatical view of the dialog definition data model of the system of FIG. 2;

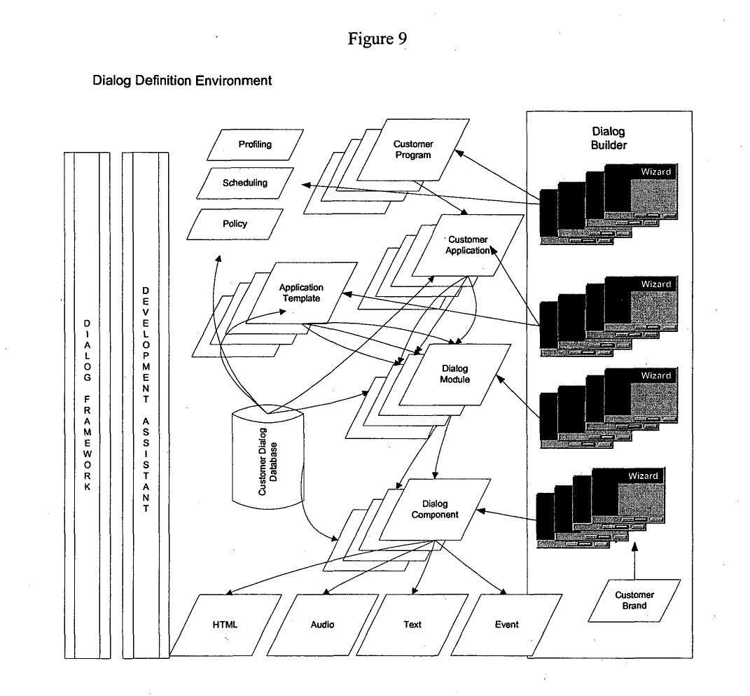

FIG. 10 shows a diagrammatical view of the execution environment of the system of FIG. 2.

FIG. 11 shows a diagrammatical view of the contact layer where data is imported and exported to customers of the system of FIG. 2;

FIG. 12 shows a diagrammatical view of an approach to identifying the receiver of a call, answering machine or human detection, for the telephone delivery according to an aspect of the present invention;

FIG. 12A shows a depiction of recipient authentication for the telephony media according to an aspect of this present invention;

FIG. 13 shows a diagrammatical view of the dialog engine for the system of FIG. 2;

FIG. 14 shows a diagrammatical view of the dialog engine interaction with the customer for the system of FIG. 2;

FIG. 15 shows a depiction of a dialog delivery process and a sample call flow according to an aspect of the present invention;

FIG. 16 shows a diagrammatical view of the system interaction with the delivery provider and customer for the system of FIG. 2;

FIG. 17 shows a diagrammatical view of an embodiment of the present invention;

FIG. 18 shows a diagrammatical view of the application assembly for the system of FIG. 2; and,

FIG. 19 shows a depiction of the system monitoring according to an aspect of this present invention.

### DETAILED DESCRIPTION OF THE INVENTION

It is to be understood that the figures and descriptions of the present invention have been simplified to illustrate elements that are relevant for a clear understanding of the present invention, while eliminating, for purposes of clarity, many other elements found in typical automated dialog systems. Those of ordinary skill in the art will recognize that other elements are desirable and/or required in order to implement the present invention. However, because such elements are well known in the art, and because they do not facilitate a better understanding of the present invention, a discussion of such elements is not provided herein.

The present invention may enable business users, such as non-technical computer users, to easily create interactive dialogs that may be customized to a recipient, such as a consumer, and that may be delivered automatically via telephone or other electronic media. The present invention may provide an easy-to-use network-based, such as Internet-based, configuration environment that enables users to visually create dialog structures, import data about recipients, schedule dialog delivery, manage execution of dialog delivery, and monitor data collection of interactive dialogs. All or a portion of these activities may be performed by the business user without exposure of the business user to the technical complexities of the underlying technology that may eventually execute communications with recipients. The present invention may also include a hardware infrastructure, and platform management and monitoring tools that enable at least one overseer to manage customer accounts and to monitor the availability of the system and the hardware infrastructure.

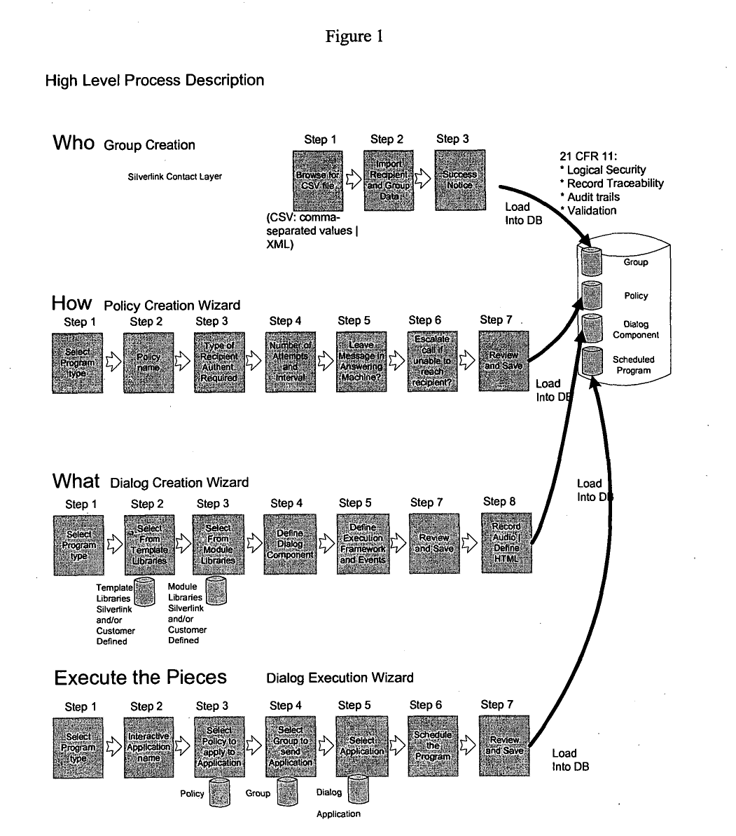

As may be seen in FIG. 1, interactive dialogs may, in certain embodiments, be simplistic, and, in other embodiments, may be increasingly complex. Dialog complexity may be reduced by the discretization of the steps that the business user is to follow. A dialog may include three top-level discretized components: (1) who is contacted; (2) what is the content of the dialog upon contact; (3) when, how, and through which delivery mechanism is contact made. Who is contacted may be determined by data imported by the business user, or imported automatically, which imported data may describe each recipient, such as a data description of John Doe including information about John Doe, such as data needed to contact John Doe, and/or the preferred mechanism to contact John Doe, and demographic data, which may be used to customize communication with John Doe. Data may additionally include batch or grouping data, such as data describing how different recipients are grouped, such as a list of all recipients who will receive a given interactive dialog. What is communicated may be defined in the dialog and by the responses of the recipient. When/how contacts are made may be defined by policy, scheduling, and profile.

The present invention may include Web-based applications for creating Voice XML (VXML), Call Control XML (CCXML), HTML, XML, and other computer code for interactive dialogs, which creation of code may occur dynamically through an intuitive process. Such applications may be written in Java, SQL, and in a standard Web Application development environment, such as ColdFusion, PHP or ASP, by way of non-limiting example.

The present invention is designed to comply with regulatory requirements that enable deployment of the present invention in a variety of settings, such as, but not limited to, healthcare settings. As such, while the present invention may allow for creation of an easy-to-use user interface for the person creating automated dialogs, the present invention may also provide: logical security of the data used or created by the application, such as by preventing unauthorized access; recordation traceability, such as by enabling reproduction of results of calls that happened in the past; and audit trails, such as by enabling the verification of changes to the application over time.

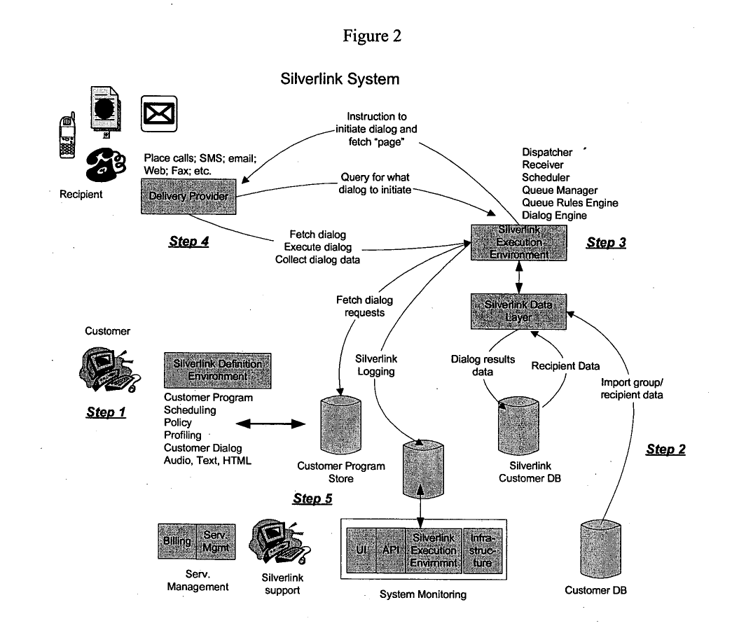

Referring now to FIG. 2, there is shown a diagrammatical view of a system according to an aspect of the present invention. This system may include a definer, a data module, an executor, an interface, and a monitor. The definer may be configured to assemble a dialog suitable to be conveyed to the recipient. The data module may be configured to load data about the recipient, or about some other suitable element of the system. The executor may be configured to execute the transmission of the assembled dialog to the recipient in accordance with the loaded data and in accordance with a given policy and schedule. The interface may be configured to interface the executor to a delivery mechanism.

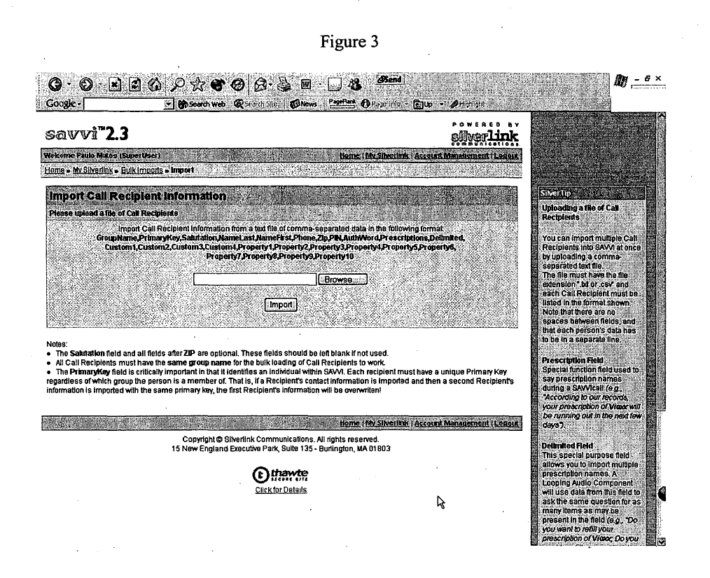

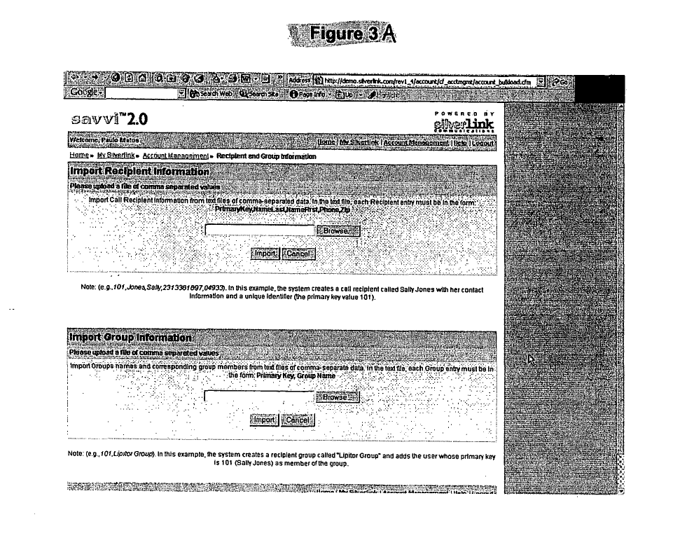

The definer may be configured to assemble information, such as dialog, data, or other information, suitable to be conveyed to the recipient. Such dialog may include content known to those possessing an ordinary skill in the pertinent arts, such as text, audio, web pages, events and logic. The definer may be configured to provide easy use and configuration of dialog, such as by utilizing a question and answer guide process, such as through a web browser, as may be seen in FIGS. 3-8A.

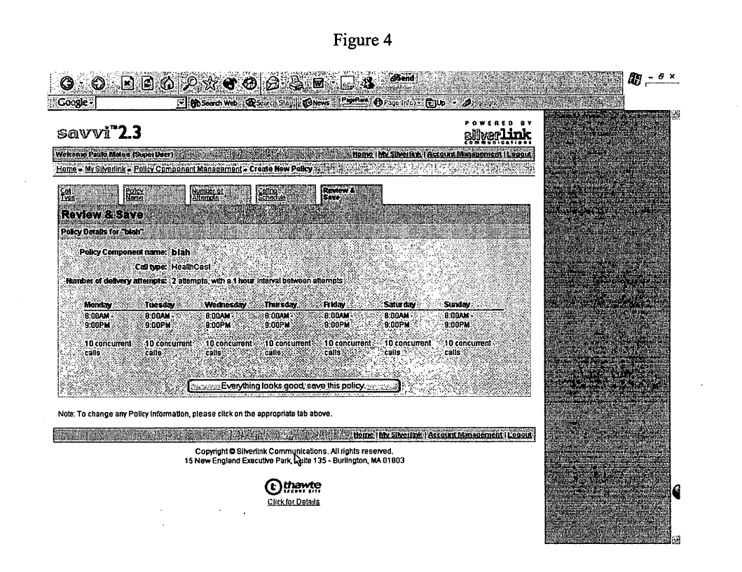

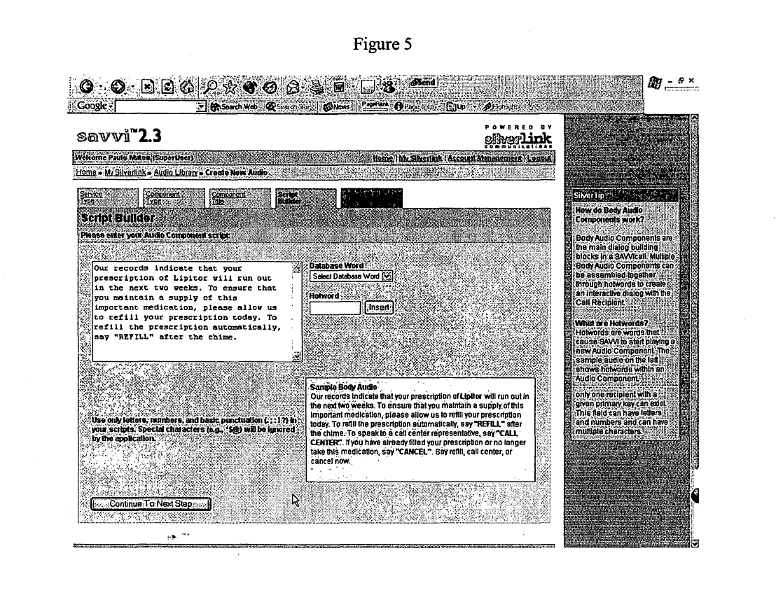

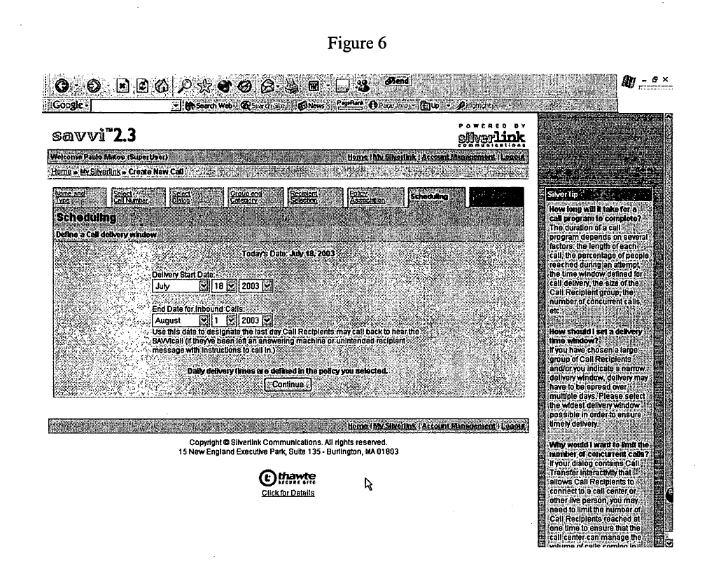

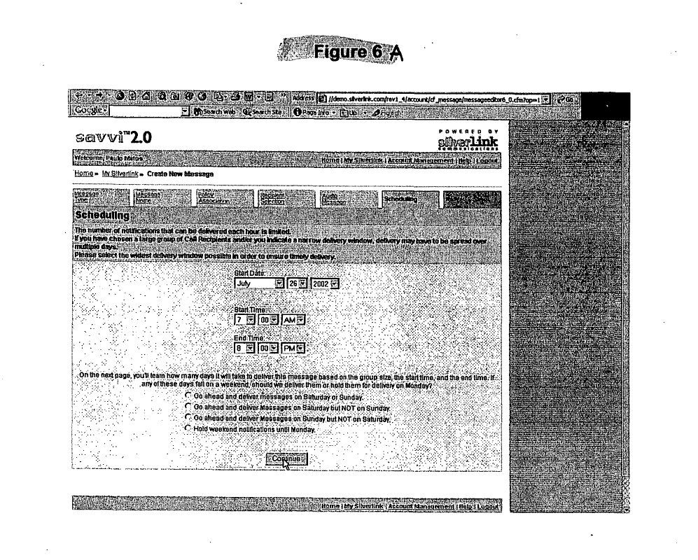

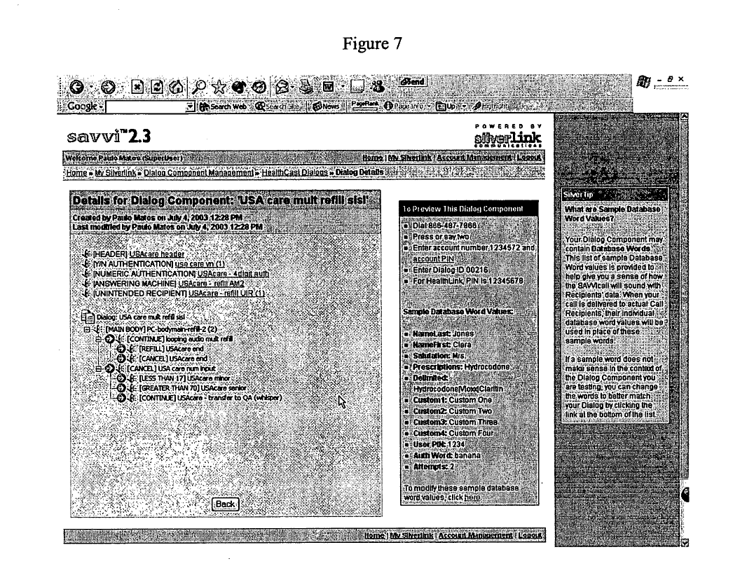

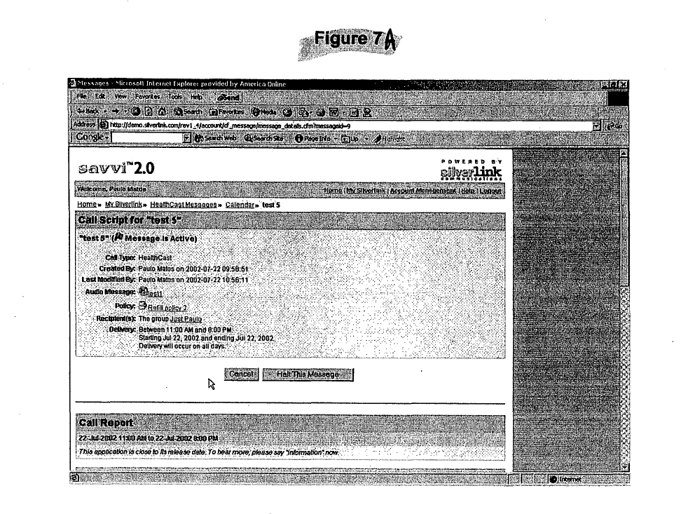

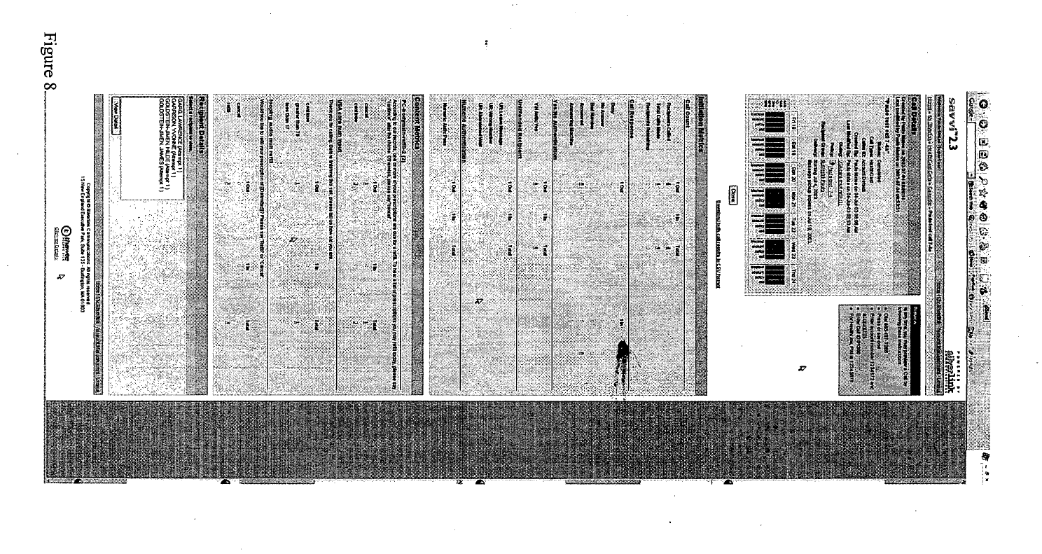

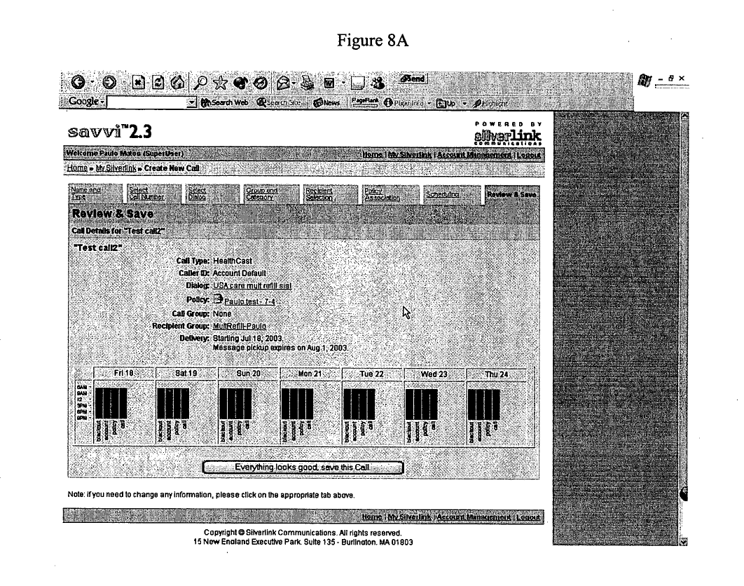

As may be seen in FIG. 3, there is shown a wizard according to an aspect of the present invention which may guide the user through the process of selecting to whom calls or contacts are to be sent, which wizard, as defined herein, may be resident within the definer, and may be controlled by the user, i.e. the configuror. In FIG. 3A there is shown a depiction of a user interface for importing recipient information according to an aspect of the present invention. This screen in FIG. 3A provides an alternative embodiment to the screen shot of FIG. 3. In FIG. 4, there is shown a policy wizard according to an aspect of the present invention, which may guide the user in selecting how the dialog will be delivered. This wizard may include a mechanism to define how the process flows, including action to be taken if the intended recipient does not respond. Also, how many attempts the program may make before moving on. As may be seen in FIG. 5, there is shown an audio wizard according to an aspect of the present invention, which may be utilized to decide and guide what audio will be delivered. Such a wizard may include a mechanism to create audio files, and may define interactivity. In FIGS. 6 and 6A, there are alternate embodiments of a screen shot for scheduling delivery of interactive calls according to an aspect of the present invention. In FIGS. 7 and 7A, there alternate embodiments of dialog wizard, which may be utilized to assemble the components into specific interactive dialogs. For example, interactive dialogs may have a variety of templates available, from which the user may select an interaction flow, rather than creating the interaction flow from scratch. For example, a template might include the interaction flow ask A, and if the answer is AB, then ask BB, but if the answer is BC, then ask CC, and so on, rather than forcing the user to create question AA, create question BB, create a decision tree assessing whether the answer to A was AB, and so on. In FIG. 8 there is shown a dialog creation summary and an interactive call report summary, respectively, which dialog creation summary demonstrates the logical security incorporated in the present invention, a record of the traceability, and audit trails for the dialog. Further, as may be seen in FIGS. 8A there is shown a call save wizard according to an aspect of the present invention. These interactive call reports may be returned to the configuror, as defined by the definer, via a desired format. Further, consequently, reporting of recipient responses may be defined by the definer to return to a point selected by the configuror for delivery to the configuror. For example, the configuror may want responses assessed by, within, or associated with, the definer (herein referred to as an assessor when assessing a response), text transcripts generated, and text forms of the responses forwarded to the email address set by the configuror.

Further, the definer may include an assistant suitable to guide the user through the dialog creation process. Such an assistant may be web-based, such as a web-based wizard, and may thereby allow the configuror to define a dialog. The assistant may handle for the configuror the complexity of dialog creation and the dialog execution. The assistant may present to the configuror an easily understandable graphic representation of the flow of the dialog, for example. This presentation of a representation may be done by any suitable method known to those skilled in the art, such as by a tree diagram, drag and drop, or tiered menus, for example. The assistant may also enable the configuror to determine when and how the recipients are to be contacted. The assistant may enable the user to define specific dialog “behavior” depending on the profile of the recipient.

The framework of the present invention may have components and rules to facilitate dialog development, such as rules programmed into the assistant, for example. Such rules and components may include pre-defined system components, such as audio, text, and HTML, and standard default behaviors, such as what to do upon receiving no response, or upon receipt of an error response. The framework may utilize the assistant to determine, or to assist the configuror in determining, the correctness of a dialog configuration. All or a subset of possible dialog configurations may be stored and recorded in a database, and dialog execution is preferably performed in accordance with the proper dialog configuration. Thereby, consistency of dialog execution with dialog configuration is ensured. Further, according to an aspect of the present invention, a hierarchy of dialog configurations may entail dialog components grouped into collections of dialog modules. These modules may be further configured or grouped into applications and application templates.

After setting up a dialog, the definer may assemble the dialog and categorize, or group, the assembled dialog into one or more sets of logically linked dialogs (for example, dialog AA has been delivered to the recipient 3 times in the past, deliver dialog AB next). Further, the definer may constrain the dialog to provide only limited choices within the dialog, thereby possibly reducing the potential for error during the dialog.

A dialog component is the foundation of dialog. A dialog component may include a statement or a question with a set of valid responses, and a series of dialog components may form a dialog module, as discussed hereinabove. A dialog component may be reusable and may be included in any number of modules. The configuror may associate audio files within an environment, or may use industry standard “text to speech” (TTS) engines, or both. Within a given dialog, variables may be used. These variables may be: (1) system wide (i.e. date, time); (2) global, created by the configuror; or (3) part of the recipient data. The environment may automatically replace a certain variable with actual data upon receipt. Further, variables may be transformed by the system into phonemes, such as a drug name may be replaced by international phonetic spelling symbols that ensure TTS engines will know how to properly enunciate that the word, for example. Dialogs and the associated attributes may be stored in one or more databases.

A dialog component may be a conversation script framework. A dialog component may have an associated execution framework, and may be used in any number of modules. Execution frameworks consist of simple programming constructs, such as sequences, loops, and cases, such as “if-then-else” constructs. Response sets, such as valid responses, may be associated with an interaction mechanism, such as numeric entry, hot word or DTMS, for example. Interaction mechanisms may be associated with programming constructs, such as a loop, where each item of a list is looped until the list is exhausted and the variable is replaced within a dialog; or a case, where the next dialog component that gets executed can be controlled by the list of valid hot words or responses. The configuror may be presented with a tree representation of these constructs, for example. Additionally, pre-built modules may be designed for unintended recipient interaction, authentication, date entry, and pre-built constructs for standard transitions, communication anomalies, such as no input, understanding DTMF, numeric entry, word entry, help, transfer, recording information, by way of non-limiting example.

Modules, which may include a collection of dialog components to perform specific functions, such as a prescription drug refill module, and which may include the logic associated with the function, such as the logic of asking the recipient if the recipient chooses to refill the prescription, may be created. These modules may be predefined, such as several versions of recipient authentication (HIPPA and SEC versions) by way of non-limiting example, name and address verification, name and address entry, and unintended recipient.

Applications and application templates may also be created. Applications and application templates may be collections of modules that perform specific business tasks, such as drug recall, prescription refill, subscription renewal, or fund raising. Application templates may be organized by industry and function. Application templates may represent actual best practice dialogs, which can be modified to create a specific dialog. Application templates may be created for, and organized by, specific industries, such as pharmaceutical, insurance, or automotive, for example. The user may select an application template as a framework and may modify it to that user's specific requirements.

When and how a dialog will be executed may be governed by rules or policies, such as the number of concurrent contacts by day of the week, number of attempts to contact each recipient, or wait time between when attempts are made. These policies may be defined through a wizard that controls the sequence in which the business user sets the correct variables in, for example, a ‘point and click’ manner. A configuror program may be scheduled for execution according to a certain policy, and/or according to certain overriding account-level settings, such as sending calls according to policy ABC, but obeying account level black-out dates when sending calls. Start and end dates for a program execution may be defined through this interaction of policies and account-level settings.

Behavior of dialog execution may depend on attributes of the recipient, such as by profiling, for example. Some changes in behavior may be pre-defined and may be automatically selected. Other profiling may be enabled within the dialog builder, such as automatic variations like recipients that may prefer to be contacted by email instead of by phone, and different voices and/or volume that may be used depending on recipient gender and age. An example of variations that may use the dialog builder is different dialog paths depending on differing socio-economic factors, such as dialog components added to dialogs that are specific to a recipient profile.

A configuror of the dialog may be a user tasked with setting the dialog up or with monitoring those who do. In this regard, accounts may be created providing a controlled access to the definer, and therefore to the creation of dialogs. In an embodiment of the present invention a list of configurors may be entered into the system. This list may include information for each configuror, such as name and address, billing rates, contacts names, by way of non-limiting example. Each team of configurors may be headed by an entity designated as a super user with a special identifier and password.

In an embodiment of the present invention, the configuror responsibilities may be divided as discussed hereinbelow. An Administrator may be an individual who creates programs and determines recipient populations to target. Further a super user may include those functions of an administrator, and additionally the super user may have access to create and/or modify accounts, to manage aspects within the account, and to manage system-wide settings. A supervisor may be required to provide approval to allow a dialog to be executed in steps discussed hereinbelow. Contact center staff may be individuals or groups that are within a grouping, such as call center agents, suitable to receive information about programs. Other professionals may be included as well, such as healthcare professionals, who may have selected access, such as individuals or groups designated for specialized follow-up.

Programs, as discussed hereinthroughout, are an aggregate collection of all items associated with dialogs that include the customer application (the dialog), the policy, including dialog specific and account-wide policy, the scheduling information, and profiling adjustment. Once a program is scheduled and the recipients and groups loaded, a program is ready for execution.

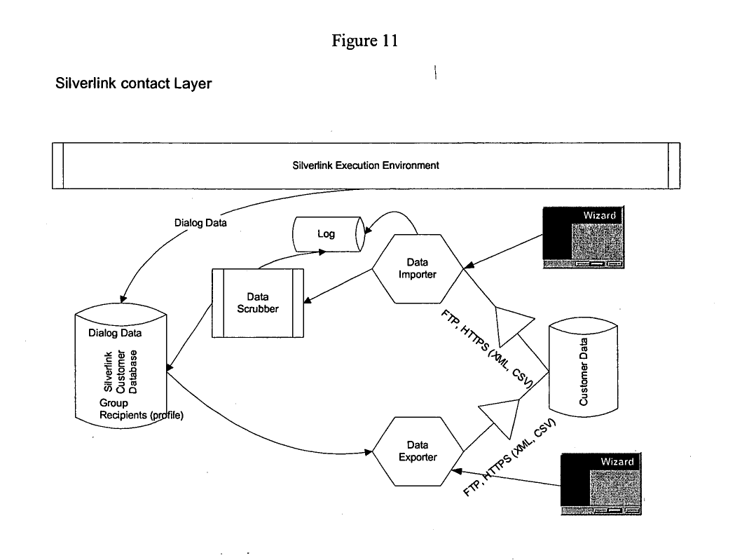

Referring now to FIG. 11, there is shown a contact layer of the system of FIG. 2. The contact layer may be configured to load data about the recipient, or the contact layer may load and manipulate data about any other suitable or necessary element of the system. This configuration may be performed by importing recipient data by file, Web page entry, or by message. Importing may utilize API and rules engine to connect with the customer. Data can be formatted in, for example, CSV, XML, or fixed length, by way of non-limiting example only. Further the data may be extracted from the data stored during the dialog. Such an extraction may occur upon dialog termination or upon configuror request. The configuror may define the set of information suitable for retrieval. The extractor may utilize a data transport layer to connect and send the information to the user. Data may be sent in a file or a message and may be formatted in CSV, XML, or fixed length, as well as audio and graphic objects. The transport layer may move data to and from the customer by connecting through HTTPS or a VPN, by way of non-limiting example only. FTP and other transfer and messaging protocols may be used.

Recipients may be individuals or entities to be contacted in an outbound program. Similarly, recipients may also be individuals expected to make contact for inbound programs. Recipients may include any combination of unexpected or expected recipients, and incoming or outbound contacted recipients. Recipient information contains items such as first name, last name, street address, phone number, email address, gender, date of birth, by way of non-limiting example only. The present invention provides the ability to use information in the recipient profile, such as health information, gender, age, and address, contact method, and time of day, incorporating for time zones, to better tailor dialogs to specific recipients. Recipient data may also be used within the dialog. Recipient data may be scanned or manipulated to fit the desired profile, such as in a comma-delineated programming, or such as a separation of first name and last name, or by the removal of unwanted information, such as “jr.”, for example. Further if certain features are required for the dialog, these features may be verified in this scanning or manipulating step.

A recipient group is a collection of recipients created for a particular program. A recipient can be part of multiple groups. Configurors may have the ability to define a set of unique information by recipient group, which provides the data that defines the purpose of the dialog.

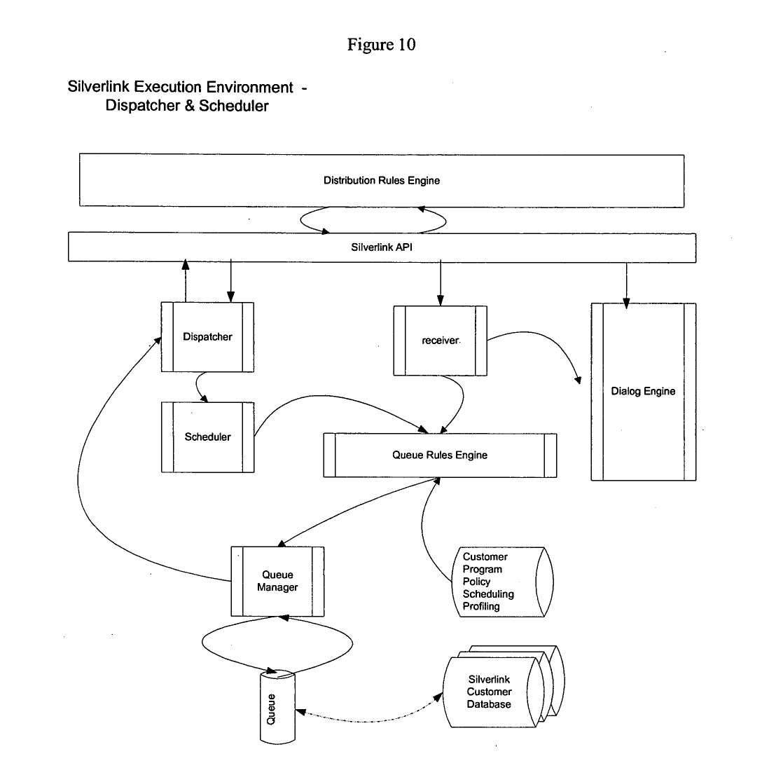

Referring now to FIG. 10, there is shown an executor of the system of FIG. 2. The executor may be configured to execute the transmission of the assembled dialog to the recipient in accordance with the loaded data. The executor may include a dispatcher, a receiver, a scheduler, a monitor, and a manager, for example. While an executor according to an aspect of the present invention may contain all of these various functions, an executor according to the present invention may provide lesser capabilities, or a subset of the listed capabilities.

For example, an assessor, such as receiver, monitor, or manager, within the present invention may be employed to utilize natural language processing to assess a response to a question in the present invention, or may constrain the answers to questions, such as by asking only close-ended questions in accordance with the definer design of the automated dialog. In constraining the answers to questions, it is possible to examine the response for so called “hotwords”. As an example, a dialog prompt for a call may include ‘please say “refill” or “cancel” after the prompt’. The present invention in response to this prompt may examine the answer as compared to these two hotwords. If one of the two hotwords is not found, a standard “error” construct may be deployed. If one of the hotwords is found the next sequential question may be announced according to the hotword received. Examining responses for hotwords may create logic and maintain a powerful environment or process speech recognition. Further, this maximizes the uses of reporting. Additionally, open-ended questions may be employed, and interaction mechanisms assessed to select the next question to be asked. However, even for open-ended questions, the present invention may allow for a reporting of entire responses, such as by speech recognition, natural language processing, or manual text transcription of the entire recipient response, although only the speech recognized responses were assessed in real time to select the next question. This limits the real time processing necessary in the present invention.

Further, for example, execution of a dialog in the present invention may eliminate delay in determining the state of an outgoing telephonic connection, i.e. answering by a person, a machine, a busy signal, or a no-answer, by “listening” for an answering machine and beginning to deliver messages in parallel rather than sequentially. Parallel delivery may be accomplished by running two concurrent threads, wherein one is recording, and the other is playing an audio, and employing logic that analyzes the recording to determine if the call was answered by an answering machine or by a human. Upon deciding what entity has answered, a pre-selected action is taken. For example, if the system decides an answering machine received the call, the system then delivers a message appropriate for answering machines. This approach substantially eliminates the delay mentioned above.

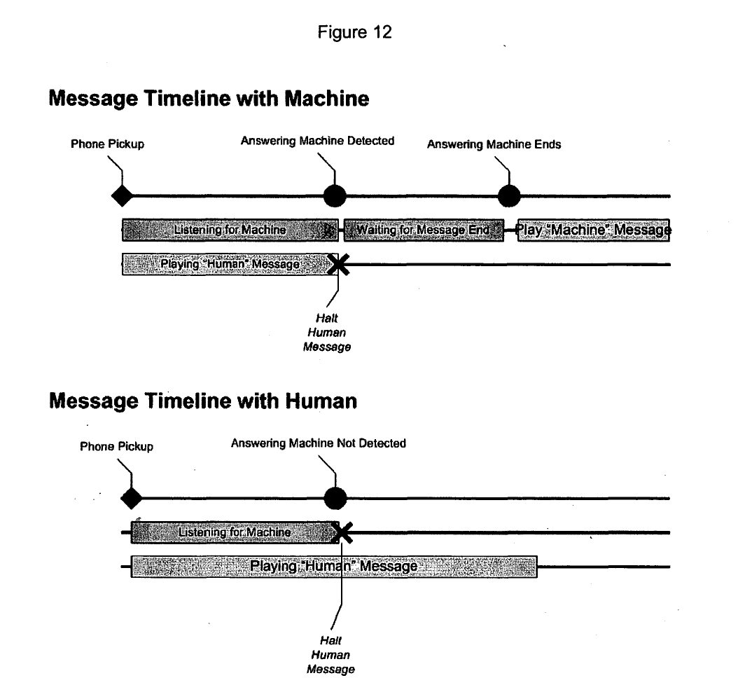

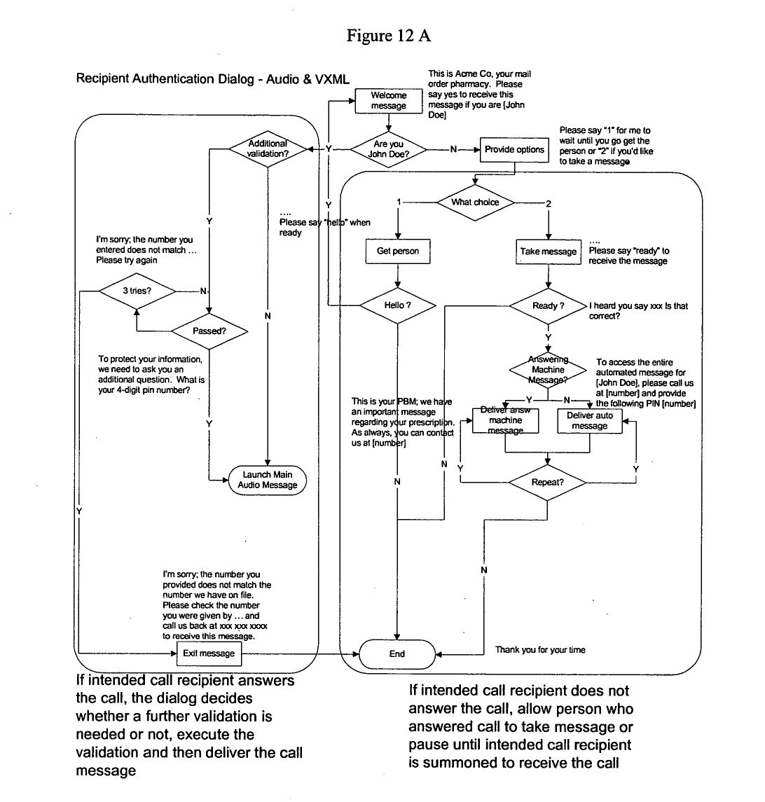

In order to create this logical analysis approach, interactive dialogs may be employed. Referring now to FIG. 12, there is shown a diagrammatical representation of the present invention detecting if the phone answerer is human or machine. The interactive dialog illustrated in FIG. 12 includes, if a machine pickup a dual processing in which the playing of the message for a human answerer, and the listening for a machine response, happens simultaneously, such a via coprocessing. If the machine is detected, the human message is halted, and then after the answering machine message is complete, the delivered machine is played. If, on the other hand, a human is detected, or the lack of a machine is detected, using the parallel processing the listening for the machine is ceased and the human message would continue.

Referring now to FIG. 12A there is shown a depiction of recipient authentication for the telephony media according to an aspect of the present invention. This authentication dialog may be utilized in audio and VXML. As may be seen in FIG. 12A, if the recipient answers the call, the dialog may make a determination of whether further validation is needed, and if the validation is not needed or is received, the dialog may deliver the call message. If the intended call recipient does not answer the call, the dialog may leave a message with the entity that answered the call or may wait until the intended recipient is retrieved to take the call. In addition, the present invention may incorporate dealing with an answering machine.

The dispatcher may be a polling process that looks for programs to be executed by starting the scheduler. The scheduler may review the programs to be executed from a customer database that has targeted recipients. The dispatcher may initiate the interaction with the delivery providers and update the queue through a rules engine with the status of the initiation. While delivery provider is enumerated as a separate element in the present invention, it is understood that this function may be performed by an element already discussed to have other functions. The dispatcher consumes the queue until empty. The dispatcher may also choose the media and delivery provider, depending and according to the program and the recipient profile. The delivery provider, upon successful status, initiates the customer application (dialog) by messaging the engine with the reference to the dialog to execute. The dispatcher may also interface with system monitoring information to provide monitoring of the overall execution environment and service provider environment. The dispatcher may slow, or stop, the number of concurrent dialogs by customer, by media type or by system wide, dependently upon the results of the overall system monitoring.

The receiver may be a passive process that waits for a “page” from the delivery provider to process dialogs that are initiated from the recipient. The delivery provider informs the receiver about the media and what type of dialog the recipient is interested in. This could be done by 800 number, for inbound calling, 800 number with unique ID, for returned outbound calls, by Web page link, Web Page link with unique ID, for out bound email, text messaging, letter, message ID, or other mechanisms, for example. The receiver may then create a queue item as determined by the rules engine, and then start the queued item. Dialogs may be received by telephony, Web, email, mail or SMS, for example.

The scheduler may determine recipients that need to be processed as defined within programs. The scheduler may notify the manager. The manager may poll the database and start populating the queue. The scheduler may wait until the manager is finished, and then may send the items to be processed to the dispatcher.

The manager, upon instruction from the scheduler, may retrieve recipients from the databases associated with the customer(s), query the rules engine, and populate the queue. When all the recipients that are to be processed at this time are placed on the queue, the manager may terminate.

The queue rules engine may be a collection of rules that determine: if a recipient interaction is to be placed onto the queue; to create a second instance of the recipient interaction on the queue for those recipients that are not reached, such as wrong person, answering machine, by way of non-limiting example only; to use logic to understand resource usage and divide it among customers, and customer programs, proportionally.

According to an aspect of the present invention, a portion of the engine may inspect data for patterns within successful and/or unsuccessful dialogs. This portion may understand the recipient profile and may use demographic information to refine the patterns. The engine may further understand the types of customer applications, such as prescription refill applications, to gain a stronger cross program, cross customer, understanding, such as a heuristic determination. This engine may enable improvements in success rates for all customers.

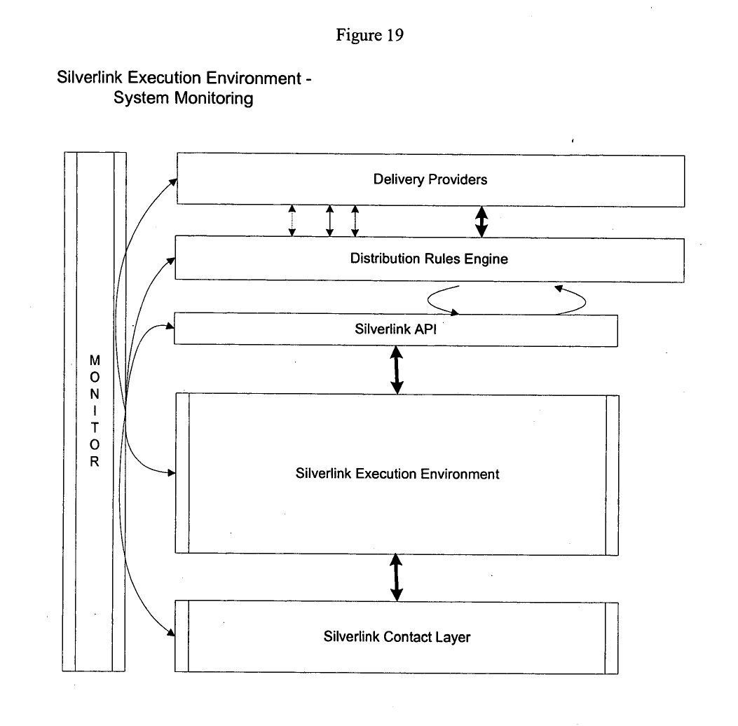

Referring now to FIG. 19, there is shown a monitor of the system of FIG. 2. According to an aspect of the present invention, a monitor may have an understanding of the executor and the delivery providers. If operations fall outside acceptable parameters, the monitor initiates alarms.

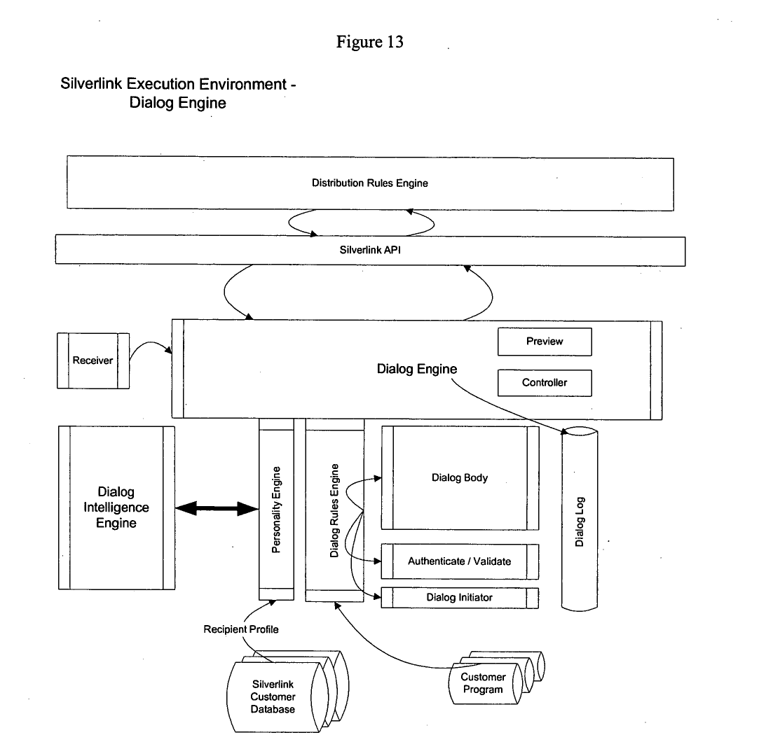

The dialog engine, as in FIG. 13, is the main interactive execution process within the present invention. The dialog engine utilizes the dialog, such as using a process similar to a computer executing a software program. The dialog engine may process each dialog component or a set of components, analyze the response or responses, manage errors, and continue execution of the dialog. Available functions within the engine may include the ability to “Preview” a dialog, such as execute the dialog with the user as the recipient, and to allow the user to manually override the execution of the dialog.

Further, the engine may include specialized parts, including the personality engine, rules engine, dialog initiator, recipient validator/authenticator, dialog body engine, dialog log, and event manager. A dialog log may be a record of the interaction of the dialog with a recipient, or other source, such as answering machine, email, letter, unintended recipient, for example. Dialog engine rules may govern each execution state of the dialog engine. States include normal, or correct conditions, and error conditions.

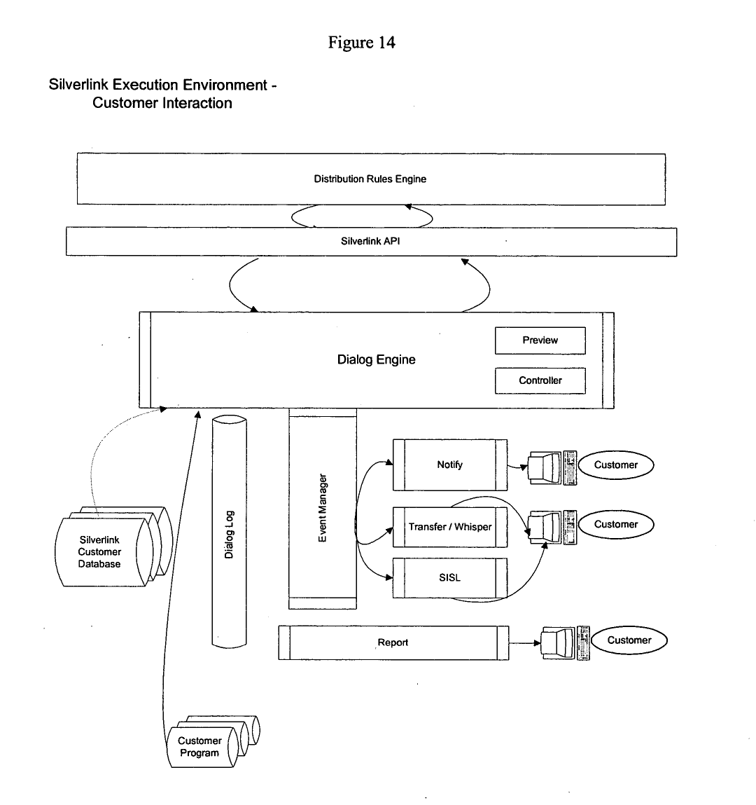

Dialog engine rules may manage, for example, depending on customer program policy; the number of retries for a response in error; and what to do upon abnormal termination, for example. The personality engine may be an optional component of the execution environment and may be invoked by defining profiling within the customer program. The personality engine may understand the “successful” patterns of the dialog provided by the dialog intelligence engine through historical data analysis (dialog flow and state analysis) or researched best practices. Depending on the customer program profiling and the profile of the recipient, the personality engine may make automatic adjustments to the dialog, scheduling and policies, changing voices depending on age and gender, for example, or use specifically defined dialog components for a profile within the customer application. Profiling may use information generated by the dialog intelligence engine, which can modify a customer program in-process by understanding the best time of day to use for optimal recipient responses. Pre-defined responses within a dialog or conditions within the dialog rules engine may trigger an event. The event manager may receive the event and may send it to the appropriate destination. Types of event destinations include, notifications to groups or individuals, screen pop, whisper, and transfer operations to customer support staff, as in FIG. 14.

Along with the ability to transfer a call (dialog) to a user, is the ability to display or speak a unique ID and other data, such as name, prior to establishing the connection. This may provide the ability to integrate into customer's operations, such as call centers, without any customization.

The present system may have the ability to transfer a dialog from the execution environment to the customer environment, such as a contact center through an ACD or Web application. Customers have the ability to view information on any customer programs or any combinations of customer programs. The system API may include internal interfaces to the execution environment. Part of the API may be made available to customers, and the API may connect the internal messages to the distribution rules engine.

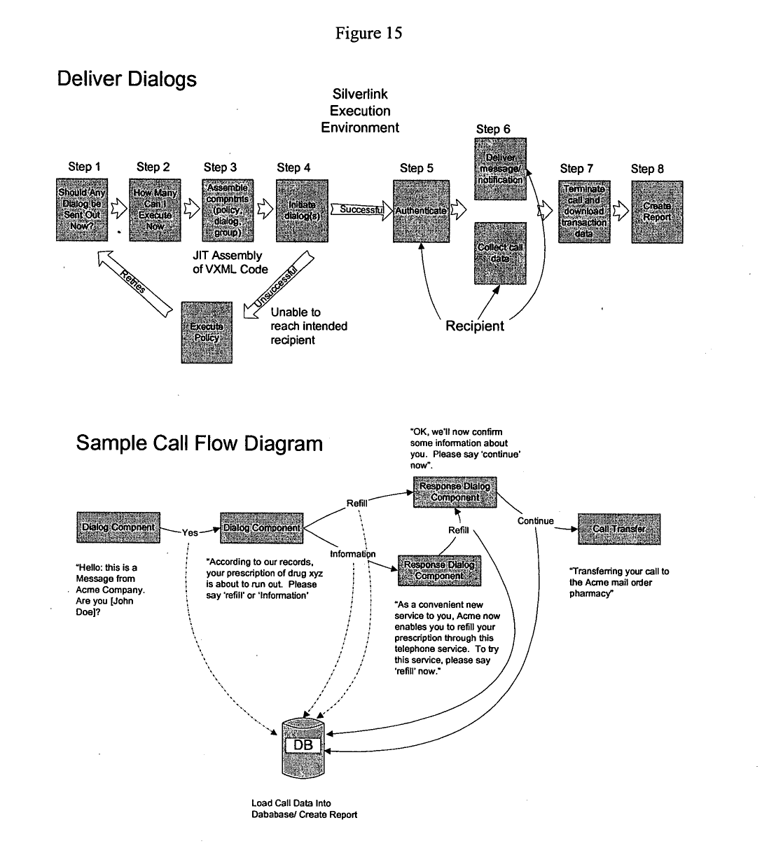

Referring now to FIGS. 13 and 14, there is shown an engine suitable for use in the system of FIG. 2. Referring also now to FIG. 15, a dialog flow diagram is shown. As may be seen, the dialog flow may proceed by beginning to send out dialogs, determining how many dialogs may be placed at the present time, assembling dialog components and policies to perform the dialog, and initiating the dialog.

Depending on the outcome of the call, execution of the policy may be necessary to determine when another call may be placed, or authentication and data collection of the call may occur. If the call is authenticated and data collection occurs, after the call is terminated disconnection and reporting may occur.

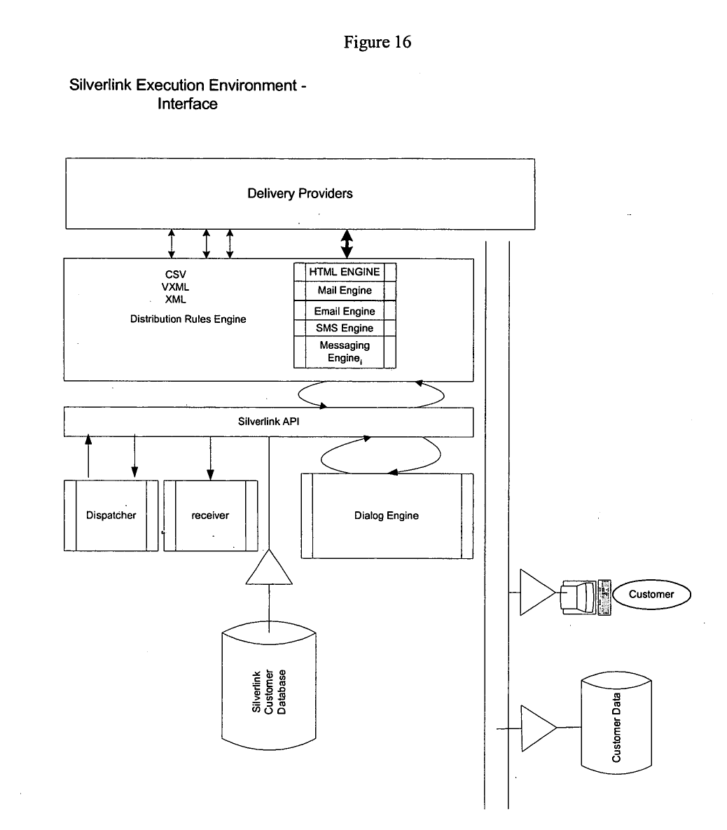

The distribution rules engine, as in FIG. 16, connects the execution environment with delivery providers and customers. The distribution rules engine converts internal formatted information to external industry standard information, and vice versa. These Industry standard formats include XML, VXML, HTML, CSV, SMS, email, by way of non-limiting example only. The distribution rules engine understands both the incoming information from delivery providers and customers, and the outgoing information and the format required, by methodologies apparent to those skilled in the art. Some interfaces require more effort than simple translations, either incoming or outgoing, thus require more processing.

XML, fixed length, and CSV forms of interaction are typically with customers. Customers can send data, such as recipients and groups, to the system, and data such as dialog results can be sent back to the customers. Secure transport mechanism include HTTPS, VPN, or secure FTP.

VXML may be used to communicate with and to telephony delivery providers. It is widely used with distributed interactive devices. Recipients do have the ability to specify the preferred mode of contact through their respective profile. Customers also have the ability to specify a primary (and/or only) mode of contact.

The HTML engine maybe used to communicate with and to Web delivery providers. The HTML engine enables dialogs to be automatically converted into Web pages, much like questionnaires or use customer pre-defined Web pages. The HTML engine understands: (1) whether the customer has pre-defined Web pages, (2) the dialog is to be displayed within a framework of an existing application, or (3) the dialog is to be displayed as set of independent Web pages. The HTML engine may consume the entire dialog, understands its flow of control, and formats it into printable pages that are presented depending on responses.

The mail engine enables dialogs to be printed into forms, much like questionnaires, or to give a phone number and/or Website to visit for responding, for example. The mail engine can consume the entire dialog, understand its flow of control, and format it into a printable page (such as a PDF or a Web page). These pages may contain instructions, such as skip to question #, to match the flow of control of the dialog. The mail engine also inspects name and address information to insure a certain level of correctness. The recipient and dialog are then sent to the delivery provider for printing and mailing.

The email engine sends out an email directly to the recipients, sends a file to an email delivery provider, or send the file of emails to the customer for emailing, for example. If the email contains an interactive component, i.e. requiring interaction with the recipient, then the email can send a PDF form attachment or it can contain a link to Web application or toll free number representation of the customer application. If the dialog is not interactive, then the email itself contains the text or HTML representation of the dialog.

The SMS engine gives the recipient a choice to interact with the customer program by other media, such as Web or telephone, or by text messages. If text messaging is chosen, the SMS engine interacts with the SMS delivery provider, much like the VXML delivery provider, sending a text representation of the dialog, one question at a time.

The system may have the ability to add other interactive media types as the industry expands into new technologies and modes of communications. Examples of this include remote devices for healthcare and automotive industries, by way of non-limiting example only.

Referring now to FIG. 16, there is shown a delivery mechanism suitable for use in the system of FIG. 2. The interface may be configured to interface the executor to a delivery mechanism. Such delivery mechanisms may include telephone, web, email, letter, or SMS delivery, by way of non-limiting example only.

The telephone delivery provider may have included therein functionality, such as a VXML interpreter, speech recognition, text-to-speech capabilities, audio files, and concurrent call capabilities. According to an aspect of the present invention, the telephone delivery provider may be able to send a “brander” caller-id suitable for interacting with the delivery provider through the dispatcher by sending a page containing the number to dial with a return UID; through the dispatcher by receiving a page containing a status with the return UID; through the receiver by receiving a page with a 800 number, URL, or UID; and/or through the dialog engine, such as by executing the logic of the dialog by sending pages containing UID, VXML and references to voice file and receiving pages with responses and UID, by way of non-limiting example only.

The web delivery provider may be a hosted site, where “frames” are sent to be displayed within the web pages. According to an aspect of the present invention, the web delivery provider may provide facilities to “brand” the dialog with graphics. The delivery provider may be communicated with through the dispatcher, such as by sending a customer first page that contains a customer program ID; through the dispatcher by receiving a page containing a status with the customer program UID; through the receiver by receiving a page with a customer program ID; and through the engine, executing the logic of the dialog by sending pages containing ID and/or HTML that optionally contains graphics files and receiving pages with responses and ID.

The letter delivery provider, outbound, may have the ability to take a formatted document, such as PDF or HTML pages, with a list of name and addresses, print the document; stuff the envelop; and mail the envelope in bulk to the intended recipients. These documents my contain either website information, phone numbers to call, or the actual dialog transposed for the media into a paper questionnaire, with multiple choice answer and some hand written portions, such as name and address correction, email address entry, and phone number entry, and other answers to non-multiple choice questions, such as numbers and names, by way of non-limiting example only. The letter delivery provider, inbound, may have the ability to scan the questionnaire, interpret the “writing” using ICR (Intelligent Character Recognition) and to convert the marks and writing into machine readable form.

The email delivery provider may send out email by broadcast, using the customer brand from address.

The SMS delivery provider may have the ability to send and receive text messages which contain information to link to a particular website or to call an 800 number or to interact with the dialog through text messages. The dialog would execute very much like a voice (telephony) dialog.

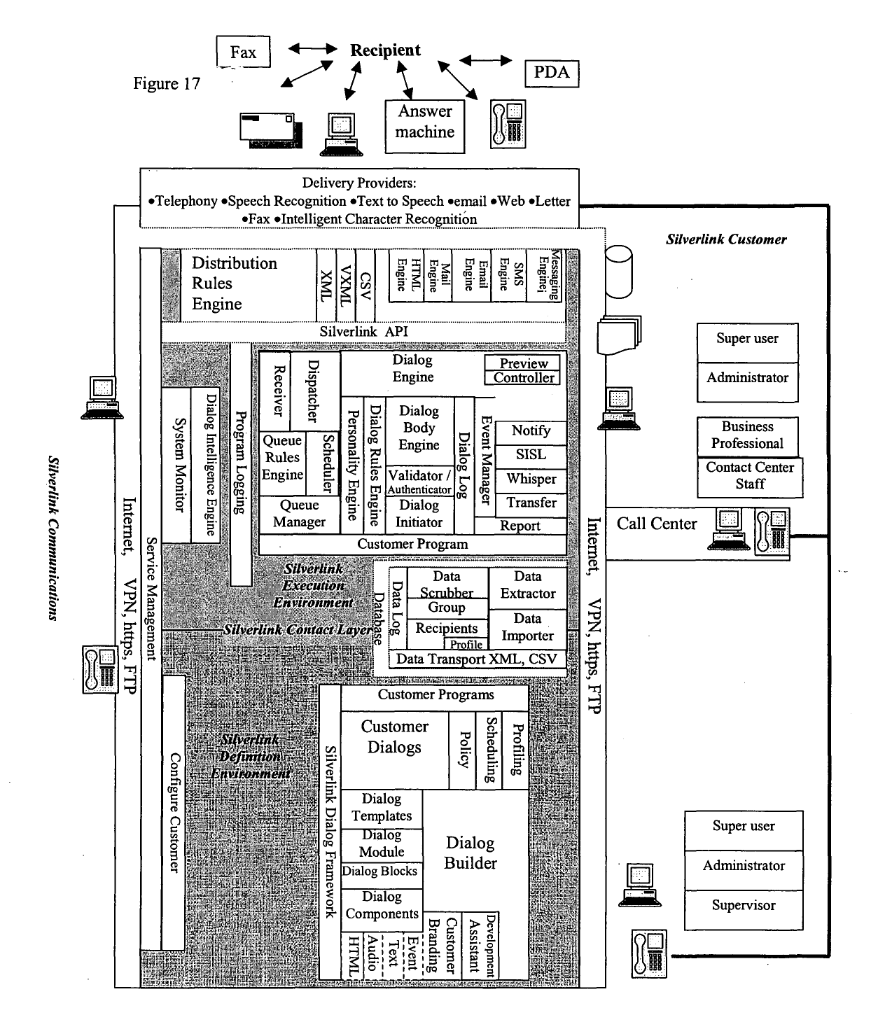

FIG. 17 provides a depiction of the present invention. Each of the particular section of FIG. 17 have been described with respect to other figures and parts of the present application.

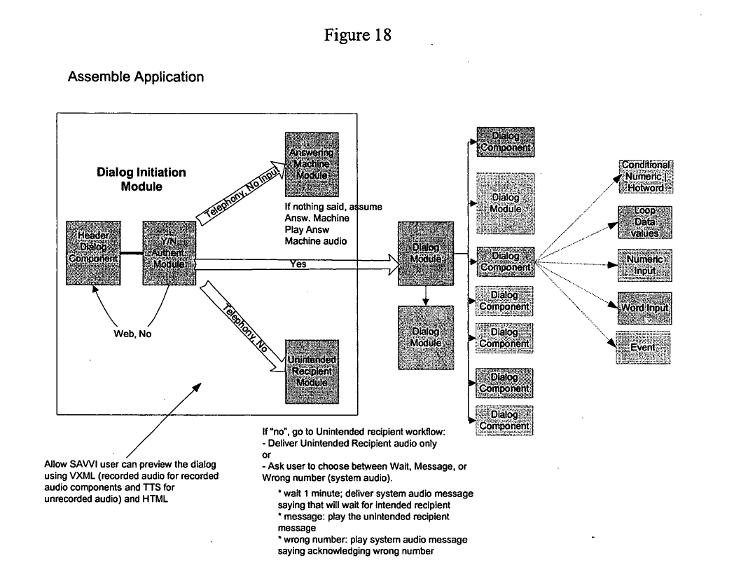

FIG. 18 shows a diagrammatical view of the application assembly for the system of FIG. 2. As may be seen in FIG. 18, an assembly may occur by determining a dialog initiation method, as described hereinabove. This selection may include web based or telephone delivery, for example. The dialog components may be built or assembled for delivery during the dialog. The assembled dialog may include module and component information as discussed hereinabove, such a conditional keywords, loop logic, event driven and scheduling.

FIG. 19 shows a depiction of system monitoring according to an aspect of this present invention. System monitoring may occur where an overseer monitors the system including the delivery providers, the distribution rules, the executor, and the contacts.

The disclosure herein is directed to the variations and modifications of the elements and methods of the invention disclosed that will be apparent to those skilled in the art in light of the disclosure herein. Thus, it is intended that the present invention covers the modifications and variations of this invention, provided those modifications and variations come within the scope of the appended claims and the equivalents thereof.

1. A system for operating at least one automated dialog, comprising:
a definer that is accessible to a configuror, wherein the definer allows for the assemblage of the at least one automated dialog via at least one non-program coding interface;
at least one data module that is incorporated into the at least one automated dialog after assemblage, wherein the at least one data module comprises at least one information item about at least one recipient of the at least one automated dialog;
an executor that incorporates the at least one automated dialog and the at least one data module into a joinder communication, and that executes an communication in accordance with the joinder communication; and
a communication interface, wherein the communication reaches the recipient through the interface.

2. The system of claim 1, wherein the executor further includes at least one assessor, wherein the assessor employs voice recognition to assess at least one interaction mechanism to the communication.

3. The system of claim 2, wherein the communication is outgoing.

4. The system of claim 2, wherein the communication is incoming.

5. The system of claim 1, wherein the communication interface includes at least one interaction mechanism.

6. The system of claim 5, wherein the at least one interaction mechanism comprises at least one close-ended response to a close-ended question to the recipient in the at least one automated dialog.

7. The system of claim 6, wherein the close-ended response is reported to the configuror.

8. The system of claim 5, wherein the at least one interaction mechanism comprises at least one open ended response to an open-ended question to the at least one recipient in the at least one automated dialog.

9. The system of claim 8, wherein the open-ended response is transcribed and reported to the configuror.

10. The system of claim 9, wherein the transcription is a full text transcription.

11. The system of claim 10, wherein the transcription is generated from a natural language recognizor.

12. The system of claim 10, wherein the transcription is generated manually.

13. The system of claim 1, wherein the definer includes at least one wizard.

14. The system of claim 13, wherein the at least one wizard provides to the configuror at least one customer application.

15. The system of claim 14, wherein the at least one customer application includes a recommendation for dialog flow of the at least one automated dialog.

16. The system of claim 1, wherein the at least one data module includes at least one recipient format.

17. The system of claim 16, wherein the at least one data module includes at least one recipient demographic information.

18. The system of claim 17, wherein the demographic information includes age.

19. The system of claim 17, wherein the recipient format is varied in accordance with the at least one recipient demographic information.

20. The system of claim 19, wherein the demographic information includes age.

21. The system of claim 17, wherein the at least one automated dialog is varied in accordance with the recipient format.

22. The system of claim 1, wherein the communication interface includes at least one selected from email, telephone, IP telephony, Web, mail and SMS.

23. The system of claim 1, wherein the communication interface is network based.

24. The system of claim 1, wherein the automated dialog includes at least one selected from the group consisting of medication adherence, health monitoring, claims adjudication, health monitoring surveys, drug-to-drug migration, change in insurance benefits and patient recruitment.

25. The system of claim 24, wherein the medication adherence comprises a prescription refill request.

26. The system of claim 25, wherein the prescription refill dialog is a close-ended dialog.

27. The system of claim 5, wherein the at least one automated dialog is varied in accordance with the interaction mechanism to the at least one automated dialog.

28. A system for executing at least one automated dialog, comprising:
at least one non-programming interface, wherein the at least one non-programming interface includes at least one graphics wizard, and wherein entry by a configuror of at least one non-programming dialog request is facilitated by receipt of at least one non-programming interaction of the configuror with the at least one graphical wizard;
a definer that is accessible to a configuror via the at least one non-programming interface, wherein the definer assembles a first portion of the at least one automated dialog in accordance with the at least one non-programming dialog request; and
an executor that incorporates the first portion of the at least one automated dialog and at least one data module into the at least one automated dialog, and that executes a communication in accordance with the at least one non-programming interface.

29. The system of claim 28, wherein the communication is outgoing.

30. The system of claim 28, wherein the communication is incoming.

31. The system of claim 28, wherein the executor further includes at least one assessor, wherein the assessor employs voice recognition to assess a response to the executed at least one automated dialog

32. The system of claim 31, wherein the assessed response comprises at least one interactive mechanism.

33. The system of claim 31, wherein the at least one interactive mechanism comprises at least one close-ended response to a close-ended question to the recipient in the at least one automated dialog.

34. The system of claim 33, wherein the close-ended response is reported to the configuror.

35. The system of claim 31, wherein the at least one interactive mechanism comprises at least one open ended response to an open-ended question to the at least one recipient in the at least one automated dialog.

36. The system of claim 35, wherein the open-ended response is transcribed and reported to the configuror.

37. The system of claim 28, wherein the at least one wizard includes at least one template for flow of the at least one automated dialog.

38. The system of claim 28, wherein the at least one data module includes at least one recipient format.

39. The system of claim 38, wherein the at least one data module includes at least one recipient demographic information.

40. The system of claim 38, wherein the at least one automated dialog is varied in accordance with the at least one recipient format.

41. The system of claim 30, wherein the at least one automated dialog is varied in accordance with the interactive mechanism to the at least one automated dialog.
